(19) United States
(12) Patent Application Publication
(10) Pub. No.: US 2011/0149099 A1
(43) Pub. Date: Jun. 23, 2011

(54) IMAGE CAPTURE DEVICE WITH ADJUSTABLE LEVEL DETECTION AND METHOD THEREOF

(75) Inventor: JUN LI, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/912,747

(22) Filed: Oct. 27, 2010

(30) Foreign Application Priority Data
Dec. 17, 2009 (CN) 200910311734.0

(51) Int. Cl. H04N 5/228

(52) U.S. Cl. 348/222.1; 348/E05.031

(57) ABSTRACT

An image capture device an with adjustable level detection function comprises a controller that determines whether the rotation angle of the image capture device exceeds a predefined angle and terminates an image capture process of the image capture device when the rotation angle exceeds the predefined angle. An image capture module of the image capture device captures images when the rotation angle is within the predefined angle.

### BACKGROUND

1. Technical Field

The present disclosure relates to a image capture device, and more particularly to an image capture device cable of adjustable level detection.

2. Description of Related Art

While electronic devices with image capture capability are popular, images captured by those electronic devices may be blurred, and their orientation imprecise, due to motion of the device. Such problems have often been solved by application of a delay initiation, in which reaction time is delayed for few seconds before images are captured, providing time to stabilize the image capture device. However, similar problems result from rotational and other axial movements of the device, not addressed by the delay initiation. Therefore, a need exists in the industry to overcome the described limitations.

### BRIEF DESCRIPTION OF THE DRAWINGS

FIG. 1 is a schematic structural diagram of one embodiment of an image capture device.

FIG. 2 is a schematic diagram of one embodiment of an user interface of the image capture device.

FIG. 3 is a flowchart illustrating one embodiment of a method for adjustably detecting the angle of the image capture device.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

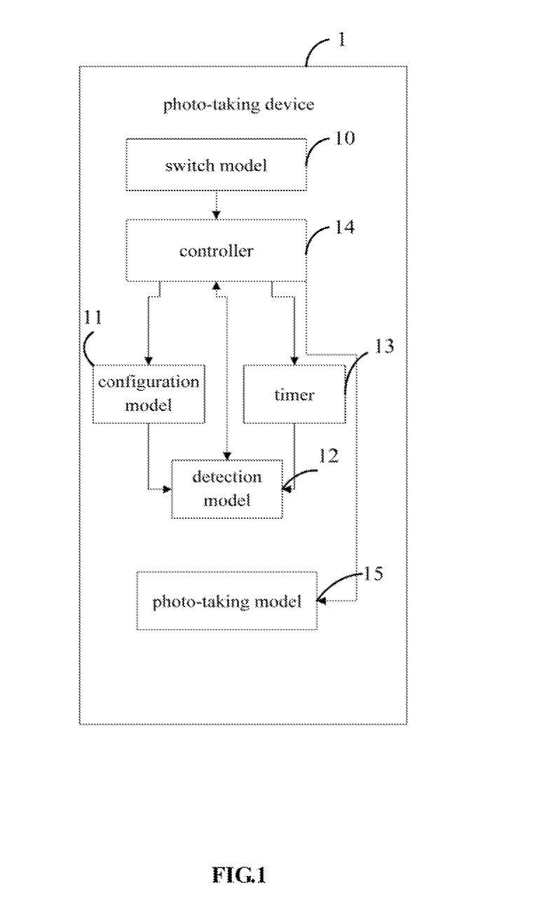

FIG. 1 is a schematic structural diagram of one embodiment of the present disclose of an image capture device 1. The image capture device 1 can be a mobile phone, digital camera, PDA, or any similar device, for example. The image capture device 1 includes a switch module 10, a configuration module 11, a detection module 12, a timer 13, a controller 14 and an image capture module 15. The switch module 10 switches user applicable functions of the image capture device 1 to a predefined image capture mode in accordance with need. In one embodiment, the user applicable functions are defined as those functions, such as dialing a phone call, playing a media stream or taking a photo, supported by the image capture device 1 and needs to be initiated by operations of users. The predefined image capture modes can be a normal mode and a rotation prevention mode, in which no image can be captured when the image capture device 1 rotates outside a predefined angle. In other embodiments, the image capture device 1 includes multiple predefined image capture modes in addition to those described.

A delay time of image capture and the predefined angle are both definable. In one embodiment, the predefined angle is defined as a maximum rotation tolerance angle of the image capture device 1 relative to the horizontal level for initiating image capture of a user applicable function when the image capturing device 1 is in the rotation prevention mode. The configuration module 11 receives input information comprising the delay time and the predefined angle for storage in the image capture device 1. At least a data group is stored in the image capture device 1, dictating the delay time and a predefined angle of the image capture device 1 used when rotation prevention mode is implemented without input of any delay time and predefined angle settings. Moreover, in one embodiment of the present disclosure, a plurality of pre-stored data groups can be selected through the I/O interface, allowing rotation prevention mode to be easily implemented without any complex configuration.

Once rotation prevention mode is implemented, when the rotation angle of the image capture device 1 exceeds that predefined during the delay time period, image capture is terminated and registered as invalid by the controller 14.

The detection module 12 detects the rotation angle of the image capture device 1 during the delay time period when the image capture device 1 is operated in the rotation prevention mode. In one embodiment of the present disclosure, the detection module 12 is implemented by a motion sensor or a rotation sensor, such as a gyroscope. The timer 13 begins to start timing a time period when image capture is activated, via the controller 14. When the time period matches the delay time and the rotation angle of the image capture device is within the predefined angle during the delay time, the image capture device 1 executes image capture function to take an image. The controller 14 determines whether the rotation angle of the image capture device detected by the detection module 12 exceeds the predefined angle in real time when the timer 13 starts.

The controller 14 also determines whether the time period of the timer 13 meets the delay time stored in the configuration module 11. In one embodiment of the present disclosure, when the rotation angle of the image capture device detected by the detection module 12 exceeds the predefined angle, the controller 14 terminates image capture by resetting the clock of the timer 13 to 0.

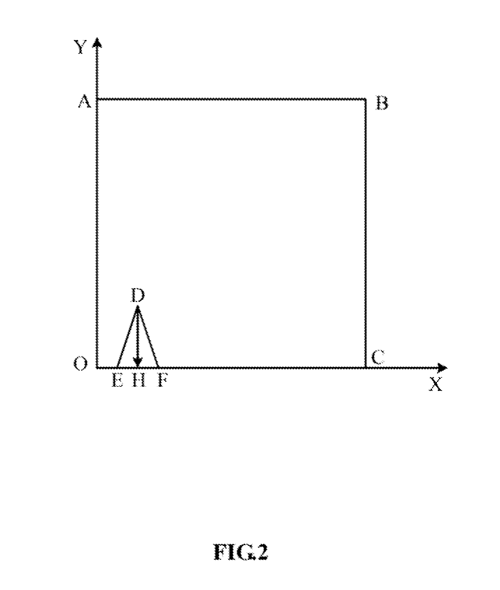

FIG. 2 is a schematic diagram of one embodiment of an user interface of the image capture device 1. The user interface is shown as the area of the rectangular area OABC at FIG. 2. The rectangular area OABC is located under a plane axis XOY. A graphical index positioned at the user interface lists the rotation angle of the image capture device 1.

The graphical index includes 2 lines D-E, D-F, and an arrow line D-H, shown in FIG. 2 at a triangle area DEF. The magnitude of the triangle area DEF shown in the rectangular area OABC corresponds to the maximum rotation tolerance angle. More particularly, in one embodiment, the angle of arc EDF is twice the maximum rotation tolerance angle compared with horizontal level, wherein the coordinate of the point D is a predetermined fixed coordinate. Coordinates of the point E and point F are amended in accordance with the variation of the maximum rotation tolerance angle. When the maximum rotation tolerance angle is increased, the point E moves along the negative direction of axis X and the point F moves along the positive direction of axis X. The arrow line D-H rotates towards right/left in accordance with the rotation angle of the image capture device 1 detected by the detection module 12.

In one embodiment of the present disclosure, since the coordinate of the point D is predetermined and fixed, and rotation angle of the image capture device 1 is detected, the direction of the arrow line D-H can be marked at the user interface in accordance with the coordinate of point D and the detected rotation angle to show the rotation state of the image capture device 1. When the arrow line D-H leaves of the triangle area DEF, the controller 14 disables image capture capability. When the arrow line D-H is within the triangle area DEF, the controller 14 enables image capture. It should be noted that the left rotation angle presents as the arrow line D-H rotation towards the negative direction of X axis and the right rotation angle presents as the arrow line D-H rotation towards the positive direction of X axis at the rectangular area OABC.

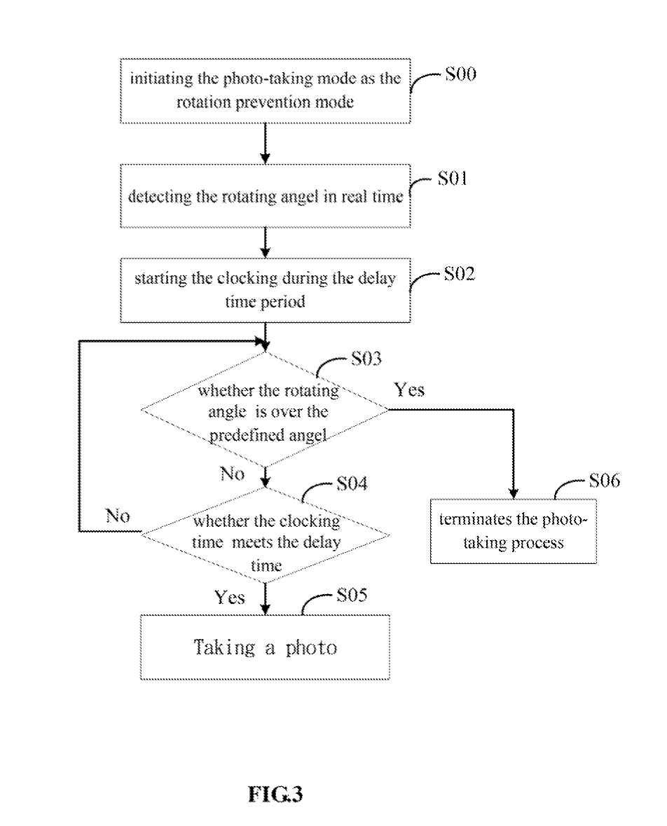

FIG. 3 is a flowchart illustrating one embodiment of a method for adjustably detecting the angle of the image capture device 1. Depending on the embodiment, additional blocks in the flow of FIG. 3 may be added, others removed, and the ordering of the blocks may be changed.

In block S00, the image capture mode of the image capture device 1 is initiated into the predefined rotation prevention mode.

In block S01, the rotation angle of the image capture device 1 is detected by the detection module 12 in real time when the image capture device 1 is rotated.

In block S02, the timer 13 timing a time period during the delay time period.

In block S03, the controller 14 determines whether the rotation angle of the image capture device 1 exceeds the predefined angle.

In block S04, when the rotation angle of the image capture device 1 is not over the predefined angle, the controller 14 determines whether the time period of the timer 13 meets the delay time stored in the configuration module 11.

In block S05, when the rotation angle of the image capture device 1 exceeds the predefined angle and the time period of the timer 13 meets the delay time stored in the configuration module 11, the controller 14 enables the image capture module 15 to take a image.

In block S06, when the rotation angle of the image capture device 1 exceeds the predefined angle, the controller 14 terminates the image capture process. In one embodiment of the present disclosure, the controller 14 terminates the image capture process by resetting the clock of the timer 13 to zero.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An image capture device with adjustable level detection function, comprising:
a configuration module that sets a predefined angle of the image capture device;
a detection module that detects a rotation angle of the image capture device;
a controller that determines whether the rotation angle of the image capture device exceeds the predefined angle and terminates an image capture process of the image capture device when the rotation angle exceeds the predefined angle; and
an image capture module that captures images when the rotation angle is within the predefined angle.

2. The image capture device of claim 1, further comprising a timer that starts timing a timing period when image capture process begins, wherein the image capture module takes image when the time period is equal to a delay time.

3. The image capture device of claim 2, wherein the delay time and the predefined angle are both definable via a user interface of the image capture device.

4. The image capture device of claim 2, further comprising a visual index indicating whether the rotation angle of the image capture device exceeds the predefined angle.

5. The image capture device of claim 2, wherein at least one data group is pre-stored in the image capture device allowing selection of delay time and predefined angle.

6. The image capture device of claim 2, further comprising a switch module switching the image capture device into a rotation prevention mode for enabling the controller.

7. A method of adjustably detection of a rotation angle of an image capture device comprising:
detecting the rotation angle of the image capture device;
determining whether the rotation angle of the image capture device exceeds the predefined angle; and
enabling an image capture function of the image capture device when the rotation angle is within the predefined angle.

8. The method of claim 7 further comprising terminating the image capture function when the rotation angle exceeds the predefined angle.

9. The method of claim 8 further comprising initiating a rotation prevention mode of the image capture device before detection of the rotation angle of the image capture device.

10. The method of claim 7 further comprising:
starting a timer during a delay time; and
enabling the image capture module to capture an image when the delay time is met.

11. The method of claim 10 further comprising a controller terminating the image capture process of the image capture device when the rotation angle exceeds the predefined angle by resetting the clock to 0.

12. The method of claim 7, wherein the rotation angle is detected in real time.
